(19) United States
(12) Patent Application Publication
(10) Pub. No.: US 2026/0321043 A1
(43) Pub. Date: Oct. 15, 2026

(54) INTERACTION METHOD AND APPARATUS, ELECTRONIC DEVICE, AND COMPUTER-READABLE STORAGE MEDIUM

(71) Applicant: Beijing Zitiao Network Technology Co., Ltd., Beijing (CN)

(72) Inventors: Youjia SHEN, Beijing (CN); Peixun ZHONG, Beijing (CN); Ziyang ZHENG, Beijing (CN)

(21) Appl. No.: 19/464,291

(22) Filed: Jan. 29, 2026

(30) Foreign Application Priority Data
Feb. 25, 2025 (CN) 202510211524.3

(51) Int. Cl. G06V 20/70; G06V 10/25; G06V 20/62

(52) U.S. Cl. CPC G06V 20/70; G06V 10/25; G06V 20/63

(57) ABSTRACT

The present disclosure relates to an interaction method and apparatus, and a computer-readable storage medium. The interaction method includes: receiving a first image input by a user; receiving a second image according to at least one of the first image or a context of interaction with the user, where the first image is a part of the second image; and displaying reply information, which is generated according to the first image and the second image.

### CROSS-REFERENCE TO RELATED APPLICATIONS

The present disclosure is based on and claims priority of CN Patent Application No. 202510211524.3 filed on Feb. 25, 2025, the disclosure of which is incorporated herein by reference in its entirety.

### TECHNICAL FIELD

The present disclosure relates to the field of computer technologies, and in particular, to an interaction method and apparatus, and a computer-readable storage medium.

### BACKGROUND

With the development of Internet technologies, an increasing number of applications have been provided with an interaction function, and such applications have become indispensable tools in people's daily life, work, and learning. Meanwhile, intelligent assistants have also been evolving, opening up new dimensions for communication between users and devices.

In the past, if a user wanted to obtain information about an image, the user would often have to spend a lot of time describing the content of the image in words. The process was not only cumbersome, but also prone to inaccurate descriptions. However, by means of algorithms, an intelligent assistant may generate replies based on pictures uploaded by a user.

### SUMMARY

According to some embodiments of the present disclosure, an interaction method is provided, including: receiving a first image input by a user; receiving a second image according to at least one of the first image or a context of interaction with the user, where the first image is a part of the second image; and displaying reply information, which is generated according to the first image and the second image.

According to some other embodiments of the present disclosure, an interaction apparatus is provided, including: an obtaining module configured to receive a first image input by a user; a determining module configured to receive a second image according to at least one of the first image or a context of interaction with the user, where the first image is a part of the second image; and a generating module configured to display reply information, which is generated according to the first image and the second image.

According to some other embodiments of the present disclosure, an electronic device is provided, including: at least one memory; and at least one processor coupled to the at least one memory, where the at least one processor is configured to, based on instructions stored in the at least one memory, perform the interaction method according to some embodiments of the present disclosure.

According to some other embodiments of the present disclosure, a non-transitory computer-readable storage medium is provided, having computer program instructions stored thereon, where the interaction method according to some embodiments of the present disclosure is implemented when the instructions are executed by a processor.

According to some other embodiments of the present disclosure, a computer program product is provided, including computer program instructions, where the interaction method according to some embodiments of the present disclosure is implemented when the computer program instructions are executed by a processor.

Other features, aspects, and advantages of the present disclosure become apparent through the following detailed description of exemplary embodiments of the present disclosure with reference to the drawings.

### BRIEF DESCRIPTION OF THE DRAWINGS

Embodiments of the present disclosure are explained hereunder with reference to the drawings. It is to be understood that the drawings in the following description relate only to some embodiments of the present disclosure and are not intended to limit the present disclosure. In the drawings:

FIG. 1 is a flowchart of an interaction method according to some embodiments of the present disclosure;

FIGS. 2A-2C are schematic diagrams of receiving a first image according to some embodiments of the present disclosure;

FIG. 3 is a schematic diagram of displaying a reply according to some embodiments of the present disclosure;

FIG. 4 is a block diagram of an interaction apparatus according to some embodiments of the present disclosure;

FIG. 5 is a block diagram of an electronic device according to some embodiments of the present disclosure;

FIG. 6 is a block diagram of an electronic device according to some other embodiments of the present disclosure.

It is to be understood that, for ease of description, the dimensions of the various parts shown in the drawings are not necessarily drawn to scale. Throughout the drawings, the same or similar reference numerals refer to the same or similar components. Therefore, once an item is defined in one drawing, it may not be discussed further in subsequent drawings.

### DETAILED DESCRIPTION OF EMBODIMENTS

The technical solutions in the embodiments of the present disclosure are described clearly and completely hereunder with reference to the drawings in the embodiments of the present disclosure. It is to be understood that the present disclosure may be implemented in various forms and should not be construed as limited to the embodiments set forth herein.

It is to be understood that the various steps recited in the method implementations of the present disclosure may be performed in a different order and/or in parallel. In addition, the method implementations may include additional steps and/or omit the steps shown. The scope of the present disclosure is not limited in this respect. Unless otherwise specified, the relative arrangements of components and steps set forth in these embodiments are to be construed as merely exemplary and do not limit the scope of the present disclosure.

The term “include/comprise” and variations thereof used in the present disclosure are open-ended terms that mean “include/comprise at least”, but do not exclude other elements/features, that is, “include/comprise but not limited to”. The term “based on” means “at least partially based on”.

It is to be noted that references to “first”, “second”, and the like in the present disclosure are merely intended to distinguish one from another apparatus, module, or unit and are not intended to limit the order or interrelationship of the functions performed by the apparatus, module, or unit. Unless otherwise specified, references to “first”, “second”, and the like are not intended to imply that the objects so described must be in a given order in terms of time, space, ranking, or in any other way.

It is to be noted that references to “one” and “a plurality” mentioned in the present disclosure are illustrative and not restrictive, and those skilled in the art should understand that they should be understood as “one or more” unless clearly indicated in the context.

Embodiments of the present disclosure are described in detail hereunder with reference to the drawings, but the present disclosure is not limited to these specific embodiments. The following specific embodiments may be combined with each other, and the same or similar concepts or processes may not be described in detail in some embodiments. In addition, in one or more embodiments, a particular feature, structure, or characteristic may be combined in any suitable manner that will be clear to those of ordinary skill in the art from this disclosure.

It is to be understood that the present disclosure is not intended to limit how an image to be applied/processed is obtained. In some embodiments of the present disclosure, the image may be obtained from a storage apparatus, such as an internal memory or an external storage apparatus. In some other embodiments of the present disclosure, a photographing component may be mobilized to take a picture. It should be noted that the obtained image may be a captured image or a frame of a captured video, which is not particularly limited thereto.

In the context of the present disclosure, an image may refer to any of a variety of images, such as a color image, a gray image, and the like. It should be pointed out that in the context of this specification, the type of an image is not specifically limited. In addition, the image may be any appropriate image, such as an original image obtained by a photographing apparatus, or an image that has been subjected to specific processing on the original image, such as preliminary filtering, anti-aliasing, color adjustment, contrast adjustment, normalization, and the like. It should be pointed out that the pre-processing operations may also include other types of pre-processing operations known in the art, which will not be described in detail here.

In the related art, when a user inputs an image, an intelligent assistant directly generates reply information according to the whole image. Direct processing of the whole image may cause the intelligent assistant to disperse energy to non-critical areas, resulting in insufficient understanding of critical information in critical areas and difficulty in meeting user needs.

The present disclosure provides an interaction method and apparatus, and a computer-readable storage medium, which may improve the accuracy and effectiveness of replies.

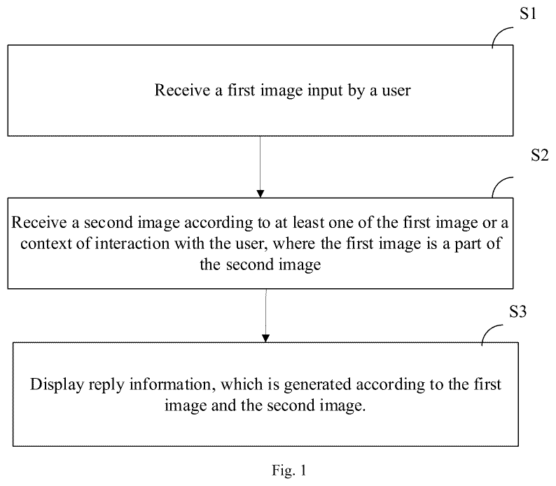

FIG. 1 is a schematic flowchart of an interaction method according to some embodiments of the present disclosure.

As shown in FIG. 1, the interaction method includes: Step S1: receiving a first image input by a user; Step S2: receiving a second image according to at least one of the first image or a context of interaction with the user, where the first image is a part of the second image; and Step S3: displaying reply information, which is generated according to the first image and the second image.

The first image represents, for example, a region of interest. The intelligent assistant or the model first receives the first image, and then determines, according to the first image and the context of interaction with the user, whether the second image is still needed to generate the reply information. If the second image still needs to be received, the reply information is generated according to the first image and the second image.

The context of interaction with the user is the dialog background and context information that is jointly formed by the content previously input by the user and the replies previously made by the intelligent assistant during the dialog process. The context of interaction facilitates understanding of the user's intention and determination of whether a suitable reply may be accurately generated without receiving the second image.

The reply information is in a form such as text, image, audio, video, and the like.

Some information in the whole image is sometimes irrelevant to the local content that the user focuses on, and may even interfere with the analysis performed by the model. Through judgment, the model or the intelligent assistant may receive the whole image only when necessary, so that it may focus more on the critical information when processing user needs, thereby improving the accuracy of analysis and reply.

The model first determines whether to receive the whole image, and receives the whole image only when the whole image is really needed, and generates the reply according to the whole image and the local image. In this way, in a case where the reply may be generated according to the local image, the response speed may be improved, and the user experience may be improved.

Moreover, the local image usually contains richer detail information, and the whole image may provide a larger-scale global feature. In a case where the whole image is needed, the accuracy of the generated reply may be improved through complementation between the local image and the whole image.

The interaction method in this embodiment may be performed on a client, or may be partially performed on a server.

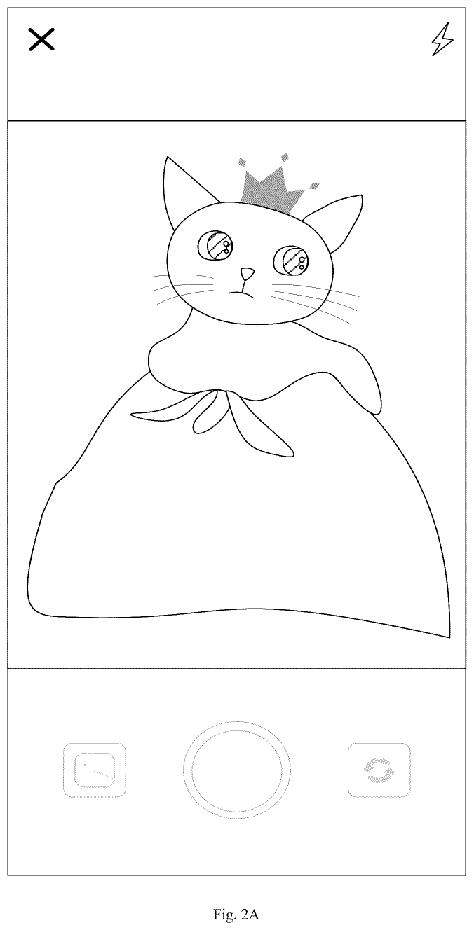

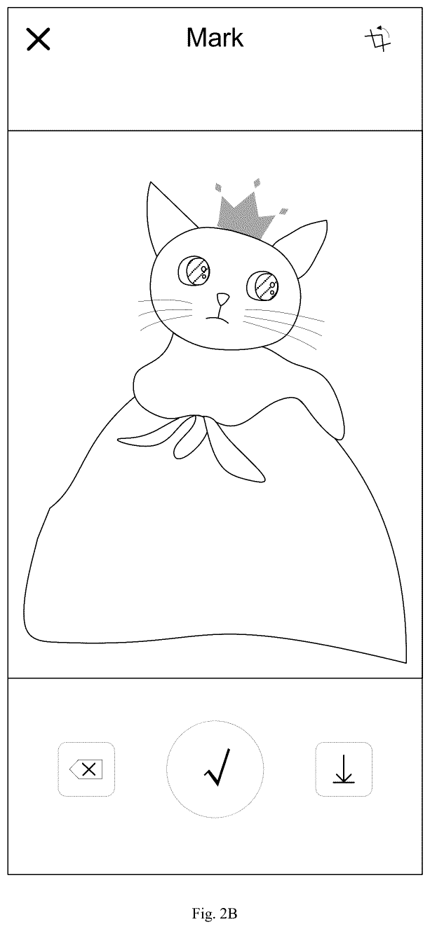

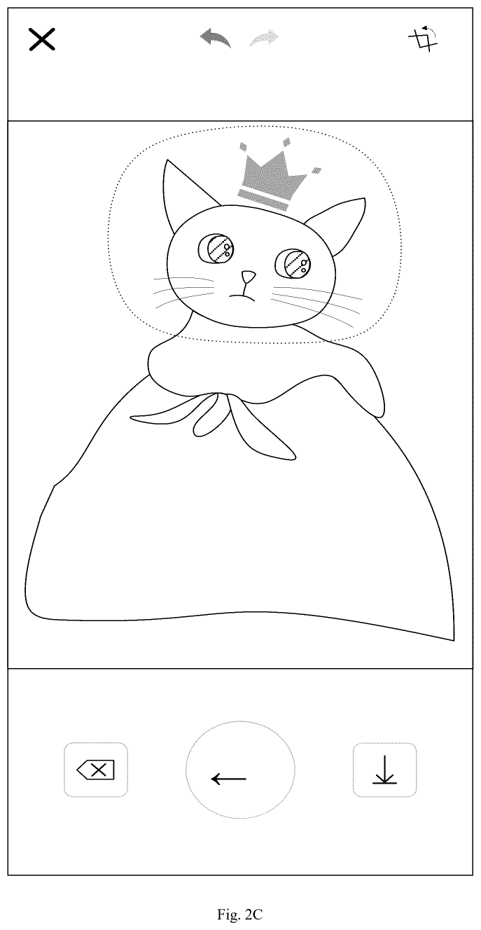

Hereunder, a method for receiving a first image input by a user according to some embodiments of the present disclosure is described with reference to FIGS. 2A-2C.

The user may trigger a control corresponding to a photographing function on a conversation interface, so as to invoke the photographing function. On the photographing interface shown in FIG. 2A, the user may take an image, which is used as a second image. The user may also open an album function by triggering a corresponding control from the conversation interface or the photographing interface. Through the album function, the user may browse images and may also select an image as the input second image.

In some embodiments, receiving the first image input by the user includes: in response to a selection operation of the user on a partial area of the second image, determining the partial area as the first image.

For example, the user may select a local area in the second image as the first image by means of clicking, box selection, or the like.

After the photographing or selection is completed, the editing interface shown in FIG. 2B is displayed. If what the user photographed or selected is a video, a frame of the video may be displayed on the editing interface. On the editing interface, the user may select a partial area of the second image. For example, as shown in FIG. 2C, the dotted line in the figure represents a mark made by the user, and the area within the dotted line is the first image selected by the user. The user may select a confirmation control, such as a check mark in FIG. 2C, to indicate that the marking is completed. After the user confirms that the marking is completed, the conversation interface is returned to, and the image with the mark may be displayed on the conversation interface.

In some instances, receiving the first image input by the user includes: displaying guidance information to guide the user to perform the selection operation; and determining the partial area selected by the user according to the guidance information as the first image.

For example, a selection tool or identification is displayed on the interface where the second image is displayed. The user may trigger the selection tool or identification to enter the selection mode for the local image. The selection tool includes, for example, a freehand selection tool, a rectangular selection tool, a brush, an eraser, and the like.

Hereunder, a method for determining whether the second image needs to be received according to some embodiments of the present disclosure is described.

In some embodiments, determining semantic information of the first image, where the semantic information of the first image includes at least one of an event, a text, an object, an action of the object, a texture, a shape, or a color in the first image; and determining whether to receive the second image according to the semantic information of the first image.

That is, whether the second image is still needed is determined according to the content of the first image. For example, there is a plant with a unique morphology in the first image, and the leaves of the plant have obvious texture, shape, color and other features. The user asks, “What is this plant?”

If the type of the plant may be determined by the texture, shape, color and other features of the plant in the first image, it is determined that there is no need to receive the second image. If the type of the plant cannot be determined, it is determined that the second image needs to be received, and the determination is made comprehensively according to the growth environment of the plant, other parts of the plant, etc. in the second image.

If there is a hand in the first image, and the hand is holding a cup. According to the context of the conversation with the user, it is determined that what the user wants to know is: “What is the person in the picture doing”. It is difficult to determine what the person is doing only based on the local semantic information of the hand holding the cup. It is possible that the person is drinking water, or may be preparing to make tea or other situations. Therefore, if the user's question is to be accurately replied, the complete image is needed, so as to know more information such as other actions and the environment of the person for comprehensive judgment.

In some embodiments, determining whether the context is related to visual information, where the visual information includes at least one of scene information or style information to which the first image belongs; and determining, in response to the context being related to the visual information, to receive the second image.

For example, if the user's intention is to determine the scene in the picture, but only grassland and a few trees may be identified in the local image, and it is not clear whether it is in a park, in the suburbs or in a community, the complete image is needed.

If the user's intention is to determine the style of a certain work of art, and at the same time, the objects in the painting are circled as a local image. In order to more accurately determine the style of the work, a complete image is also needed.

If the context is only related to local visual information, it is determined not to receive the second image. For example, according to the context with the user, it is determined that the user's intention is to determine whether the camera in the image is an old-fashioned camera. The intelligent assistant identified a corner of a device with leather wrapping, obvious metal parts and vintage shape in the local image. From the style of the local image, the item has a vintage shape and conforms to some appearance features of an old-fashioned camera. According to the style information of the local image and the user's contextual inquiry, it may be determined that there is an old-fashioned camera in the photo (because the features of the device in the local image conform to the old-fashioned camera), so in this case, a complete image is not needed, and the determination may be made only through the local image and the context.

If the user's intention is to know what event is being held in the picture. The local image shows a group of people dressed in sportswear, some holding a relay baton in their hands and some making a starting or sprinting posture. It may be determined that a relay race is being held only based on the event shown in the local image. In this case, the user's question may be accurately replied without receiving the complete image.

In some embodiments, generating first reply information according to the first image; and determining, in response to the first reply information not meeting a target, to receive the second image.

For example, a generation model is used to first analyze the local image, identify the features (such as events, colors, objects, phenomena, biological behaviors, etc.) in the image, and generate initial reply information according to these features. Then, a discriminative model is used to determine whether the initial reply information meets the user's needs. If not, the second image is received, and the reply information is generated according to the first image and the second image together.

When determining whether the initial reply information meets the user's needs, it is possible to determine the matching between the user's intention and the initial reply information based on some preset indicators and also in combination with the analysis of the interaction context.

In some embodiments, determining, in response to the initial reply information meeting the target, not to receive the second image.

That is, if the initial reply information meets the user's needs, it is determined that there is no need to receive the second image, and the initial reply information is directly fed back to the user as the reply information.

For example, if the user has photographed multiple math problems on a page of paper, and each math problem is answered independently. The user circled one of the problems, and the circled area is the first image, indicating that the user hopes to know the answer to this problem. If the intelligent assistant has been able to solve the answer according to the first image, there is no need to receive other irrelevant problems in the complete image.

In some embodiments, the context includes a processing instruction, and the interaction method further includes: recognizing a text in the first image; and determining, in response to the processing instruction being a semantic processing instruction for the text, to receive the second image.

The text may be associated with surrounding comments, descriptions, other paragraphs, etc. in the image, and the local image cannot present such information, which is not conducive to a comprehensive understanding of the text.

If the processing instruction is to translate, summarize, expand, explain the text in the local image, or perform reasoning and argumentation based on the text, the natural language processing model needs to receive the complete image to receive more contextual information and improve the accuracy of the answer.

In some embodiments, the context includes a processing instruction, and the interaction method includes: recognizing a text in the first image; and determining, in response to the processing instruction being an extraction instruction for the text, not to receive the second image.

For example, if the user wants to extract part of the text in the second image, the user may only circle the area where the part of the text is located as the first image. Then the intelligent assistant only performs optical character recognition on the text in the first image, and does not need to recognize other text in the second image. In this way, on the one hand, the calculation amount of the intelligent assistant is reduced, and the reply efficiency is improved. On the other hand, compared with sending all the text of the second image to the user after extraction, in this way, the user does not need to manually select the required part of the text from all the received text of the second image.

Hereunder, a method for generating reply information according to some embodiments of the present disclosure is described.

In some embodiments, the reply information is generated by a machine learning model according to the first image, the second image, and prompt information, where the prompt information indicates that the first image is the region of interest of the user.

That is, for the user's mark on the picture, corresponding guidance or prompt words are added in the engineering link to make the answer of the model more focused. The prompt words are, for example: “The user has marked the critical area in the image, please focus on this area to generate an answer”. The prompt words, the first image and the second image are input into the model together, and the model may focus on the features of the first image according to the prompt words.

In some embodiments, the reply information is generated by the machine learning model according to the first image, a first weight of the first image, the second image, and a second weight of the second image, where the first weight and the second weight are determined according to the prompt information, and the first weight is greater than the second weight.

For example, the model assigns different weights to different regions. The first image that the user focuses on is given a higher weight. When the model performs operations such as feature extraction, analysis, and reasoning, more attention will be paid to the information in these regions.

For example, when performing an image classification task, for a region that contains a critical object and that is focused on by the user, the model will pay more attention to extracting features such as the color, texture, and shape of this region, and give these features greater weights when comprehensively determining the image category. In an image generation task, details and content related to the region focused on by the user will also be generated more precisely based on a high weight of the region, so that the generation result is more in line with user expectations.

The model may use methods such as an attention mechanism, to implement weight assignment. For example, the model dynamically calculates an importance score for each region based on the attention mechanism, and adjusts the weight according to the score, enabling the model to adaptively focus on the important region that the user focuses on, while relatively weakening the influence of other unimportant regions.

Different users may have different focuses on the same image, and the above solution may be flexibly adjusted according to the needs of different users, thereby improving the matching degree between the generated reply and the user's intention. Moreover, for the region that is focused on by the user and that has a high weight, the model may invest more computing power for fine processing; for a region with a low weight, relatively rough processing may be performed, thereby improving the operating efficiency of the model, and reducing calculation time and resource consumption.

In some embodiments, in response to determining not to receive the second image, the reply information is generated according to the first image.

For example, the local image has provided sufficient information to generate an accurate and detailed reply. In this case, the complete image is no longer received, and when the reply is generated, relevant information or explanation may be directly provided according to the specific content in the local image, or a new picture may be generated. In this way, the user may more freely choose the local image, and the intelligent assistant or the model may more precisely perform analysis and reply around the focus that the user pays attention to, reducing interference from irrelevant information in the whole image. Therefore, in this case, not only time and resources may be saved, but also the accuracy and effectiveness of the reply may be improved.

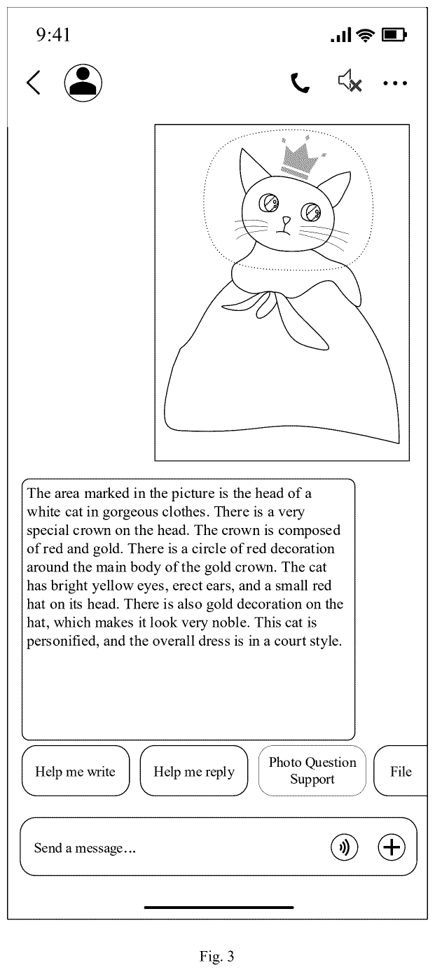

FIG. 3 is a schematic diagram of displaying a reply according to some embodiments of the present disclosure.

The model generates a reply according to the first image and the second image, and focuses on the content of the first image. As shown in FIG. 3, the generated reply information includes not only the content of the complete image, but also focuses on the image content of the area circled by the user.

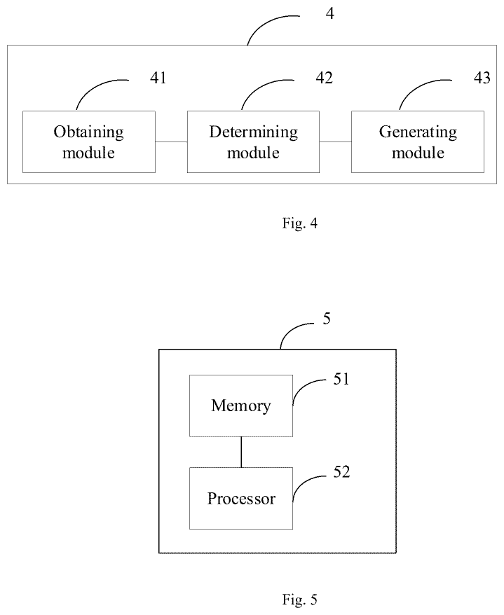

FIG. 4 is a block diagram of an interaction apparatus according to some embodiments of the present disclosure.

As shown in FIG. 4, the interaction apparatus 4 includes: an obtaining module 41 configured to receive a first image input by a user; a determining module 42 configured to receive a second image according to at least one of the first image or a context of interaction with the user, where the first image is a part of the second image; and a generating module 43 configured to display reply information, which is determined according to the first image and the second image.

The obtaining module 41 of the interaction apparatus 4 may be configured to perform step S1 in FIG. 1. The determining module 42 may be configured to perform step S2 in FIG. 1. The generating module 43 may be configured to perform step S3 in FIG. 1.

In some embodiments, the generating module 43 is further configured to: generate, in response to determining not to receive the second image, the reply information according to the first image.

According to some embodiments of the present disclosure, the interaction apparatus first determines whether to receive the whole image, and only receives the whole image when it is really needed, and generates the reply according to the whole image and the local image. In this way, in the case where the reply may be generated according to the local image, the response speed may be improved, and the user experience may be improved. Moreover, the local image usually contains richer detail information, and the whole image may provide a larger-scale global feature. In the case where the whole image is needed, the accuracy of the generated reply may be improved through complementation between the local image and the whole image.

According to some other embodiments of the present disclosure, an electronic device is provided, including: a memory; and a processor coupled to the memory, where the processor is configured to, based on instructions stored in the memory, perform the interaction method according to some embodiments of the present disclosure.

According to some embodiments of the present disclosure, the electronic device first determines whether to receive the whole image, and only receives the whole image when it is really needed, and generates the reply according to the whole image and the local image. In this way, in the case where the reply may be generated according to the local image, the response speed may be improved, and the user experience may be improved. Moreover, the local image usually contains richer detail information, and the whole image may provide a larger-scale global feature. In the case where the whole image is needed, the accuracy of the generated reply may be improved through complementation between the local image and the whole image.

FIG. 5 is a block diagram of an electronic device according to some embodiments of the present disclosure.

The memory 51 is configured to store one or more computer-readable instructions. The memory 51 may include any combination of various forms of computer-readable storage media, such as volatile memory and/or non-volatile memory, including but not limited to random access memory (RAM), dynamic random access memory (DRAM), static random access memory (SRAM), read-only memory (ROM), and flash memory. The memory 51 may store, for example, an operating system, applications, a boot loader, a database, and other programs, and may also store various applications, various data, and the like.

The processor 52 is configured to run the computer-readable instructions to implement the method of any one of the above embodiments. For the specific implementation of each step of the method, reference may be made to the above embodiments, and the repeated parts are not described herein.

The processor 52 may be configured to perform the steps in FIG. 1. The processor 52 may be embodied as various processing apparatuses, such as a central processing unit (CPU), a network processor (NP), etc. ; and may also be a digital signal processor (DSP), an application specific integrated circuit (ASIC), a field programmable gate array (FPGA) or other programmable logic devices, a discrete gate or transistor logic device, or a discrete hardware component. The central processing unit (CPU) may have an X86 or ARM architecture or the like.

The processor 52 and the memory 51 may directly or indirectly communicate with each other. For example, the processor 52 and the memory 51 may communicate through a network. The network may include a wireless network, a wired network, and/or any combination of a wireless network and a wired network. The processor 52 and the memory 51 may also communicate with each other through a system bus, which is not limited in the present disclosure.

It should be noted that the components of the electronic device 5 shown in FIG. 5 are only exemplary and non-restrictive, and the electronic device 5 may have other components according to actual application needs. The processor 52 may control other components in the electronic device 5 to perform desired functions.

The electronic device 5 may be implemented by means of software, firmware, and/or hardware, and may be integrated in an apparatus in which relevant applications are installed.

According to some other embodiments of the present disclosure, a computer-readable storage medium is provided, having computer program instructions stored thereon, where the interaction method according to some embodiments of the present disclosure is implemented when the instructions are executed by a processor. The processor first determines whether to receive the whole image, and only receives the whole image when it is really needed, and generates the reply according to the whole image and the local image. In this way, in the case where the reply may be generated according to the local image, the response speed may be improved, and the user experience may be improved. Moreover, the local image usually contains richer detail information, and the whole image may provide a larger-scale global feature. In the case where the whole image is needed, the accuracy of the generated reply may be improved through complementation between the local image and the whole image.

According to some other embodiments of the present disclosure, a computer program product is provided, including computer program instructions, where the interaction method according to some embodiments of the present disclosure is implemented when the computer program instructions are executed by a processor. The processor first determines whether to receive the whole image, and only receives the whole image when it is really needed, and generates the reply according to the whole image and the local image. In this way, in the case where the reply may be generated according to the local image, the response speed may be improved, and the user experience may be improved. Moreover, the local image usually contains richer detail information, and the whole image may provide a larger-scale global feature. In the case where the whole image is needed, the accuracy of the generated reply may be improved through complementation between the local image and the whole image.

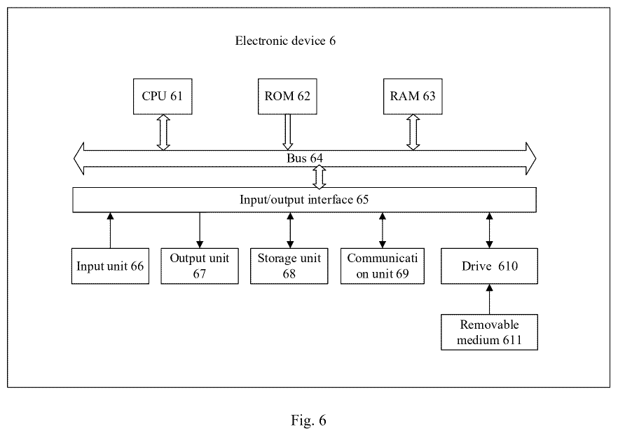

FIG. 6 is a block diagram of an electronic device according to some other embodiments of the present disclosure.

The electronic device 6 shown in FIG. 6 may be a computer system with a dedicated hardware structure, and may perform corresponding functions when relevant applications are installed.

The electronic device includes, but is not limited to, mobile terminals such as smartphones, notebooks, personal digital assistants (Personal Digital Assistant, PDA), tablet personal computers (Tablet Personal Computer, Tablet PC), portable media players (PMP), in-vehicle terminals (such as car navigation terminal), and wearable devices, and fixed terminals such as digital TVs and desktop computers.

As shown in FIG. 6, a central processing unit (CPU) 61 executes various processes according to a program stored in a read-only memory (ROM) 62 or a program loaded from a storage unit 68 into a random access memory (RAM) 63. The RAM 63 stores therein data required when the CPU 61 executes the various processes and the like as needed. The central processing unit is merely exemplary, and other types of processors such as the various processors described above may also be used. The ROM 62, the RAM 63, and the storage unit 68 may be various forms of computer-readable storage media. It should be noted that although the ROM 62, the RAM 63, and the storage unit 68 are shown separately in FIG. 6, one or more of them may be combined or located in the same or different memories or storage modules.

The CPU 61, the ROM 62, and the RAM 63 are connected to each other via a bus 64. An input/output interface 65 is also connected to the bus 64.

The following components are connected to the input/output interface 65: an input unit 66 such as a touch screen, a touchpad, a keyboard, a mouse, an image sensor, a microphone, an accelerometer, and a gyroscope; an output unit 67 including a display such as a cathode ray tube (CRT) and a liquid crystal display (LCD), a speaker, a vibrator, and the like; the storage unit 68 including a hard disk, a magnetic tape, and the like; and a communication unit 69 including a network interface card such as a LAN card and a modem. The communication unit 69 allows communication processing to be executed via a network such as Internet. It is easy to understand that although the components in the electronic device 6 are shown in FIG. 6 to communicate through the bus 64, they may also communicate through a network or other means, where the network may include a wireless network, a wired network, and/or any combination of a wireless network and a wired network.

A drive 610 is also connected to the input/output interface 65 as needed. A removable medium 611 such as a magnetic disk, an optical disc, a magneto-optical disc, and a semiconductor memory is installed on the drive 610 as needed, so that a computer program read therefrom is installed into the storage unit 68 as needed.

In a case where the above-described series of processes are implemented by software, a program constituting the software may be installed from a network such as Internet or a storage medium such as the removable medium 611.

According to the embodiments of the present disclosure, the process described above with reference to the flowchart may be implemented as a computer software program. For example, some embodiments of the present disclosure include a computer program product that, when running on a computer, causes the computer to implement the method according to any one of the above embodiments. The computer program product includes computer instructions carried on a computer-readable medium, including program code for performing the method shown in the flowchart. In such an embodiment, the computer instructions may be downloaded and installed from a network through the communication unit 69, or installed from the storage unit 68, or installed from the ROM 62. When the computer program is executed by the CPU 61, the method of the embodiments of the present disclosure is executed.

It should be noted that, in the context of the present disclosure, the computer-readable medium may be a tangible medium that may contain or store a program for use by or in combination with an instruction execution system, apparatus or device.

The computer-readable medium may be a computer-readable storage medium, a computer-readable signal medium, or any combination of the above two.

The computer-readable storage medium includes, but is not limited to, an electrical, magnetic, optical, electromagnetic, infrared, or semiconductor system, apparatus, or device, or any suitable combination of the above. More specific examples of the computer-readable storage medium may include, but are not limited to: an electrically connected portable computer magnetic disk having one or more wires, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus, or device. The computer-readable storage medium has computer instructions stored thereon, and the method according to any one of the above embodiments is implemented when the instructions are executed by a processor.

The computer-readable signal medium may include a data signal propagated on a baseband or as a part of a carrier wave, and computer-readable program code is carried thereon. This propagated data signal may adopt various forms, including but not limited to an electromagnetic signal, an optical signal, or any suitable combination of the above. The computer-readable signal medium may also be any computer-readable medium other than the computer-readable storage medium, and the computer-readable signal medium may send, propagate, or transmit a program for use by or in combination with an instruction execution system, apparatus, or device. The program code contained on the computer-readable medium may be transmitted by any suitable medium, including but not limited to: a wire, an optical cable, a radio frequency (RF), or any suitable combination of the above.

The above-described computer-readable medium may be included in the above-described electronic device, or may exist alone without being assembled into the electronic device.

In some embodiments, there is further provided a computer program, including: instructions that, when executed by a processor, cause the processor to perform the method according to any one of the above embodiments. For example, the instructions may be embodied as computer program code.

In the embodiments of the present disclosure, the computer program code for performing the operations of the present disclosure may be written in one or more programming languages or a combination thereof, where the above-described programming languages include but are not limited to object-oriented programming languages such as Java, Smalltalk, and C++, and further include conventional procedural programming languages such as “C” language or similar programming languages. The program code may be executed entirely on a user computer, partly on the user computer, as a stand-alone software package, partly on the user computer and partly on a remote computer, or entirely on the remote computer or server. In the case of involving a remote computer, the remote computer may be connected to the user computer through any kind of network (including a local area network (LAN) or a wide area network (WAN)), or may be connected to an external computer (for example, connected by using Internet provided by an Internet service provider).

The flowcharts and block diagrams in the drawings illustrate the possibly implemented architectures, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The functions described above may be at least partially performed by one or more hardware logic components. For example, without limitation, exemplary hardware logic components that may be used include: a field programmable gate array (FPGA), an application specific integrated circuit (ASIC), an application specific standard product (ASSP), a system on chip (SOC), a complex programmable logical device (CPLD), and the like.

Although some specific embodiments of the present disclosure have been described in detail through examples, those skilled in the art should understand that the above examples are only for illustration, and are not intended to limit the scope of the present disclosure. Those skilled in the art should understand that the above embodiments may be modified without departing from the scope and spirit of the present disclosure. The scope of the present disclosure is defined by the appended claims.

What is claimed is

1. An interaction method, comprising:
receiving a first image input by a user;
receiving a second image according to at least one of the first image or a context of interaction with the user, wherein the first image is a part of the second image; and
displaying reply information, which is generated according to the first image and the second image.

2. The interaction method according to claim 1, further comprising:
determining semantic information of the first image, wherein the semantic information of the first image comprises at least one of an event, a text, an object, an action of the object, a texture, a shape, or a color in the first image; and
determining whether to receive the second image according to the semantic information of the first image.

3. The interaction method according to claim 1, further comprising:
determining whether the context is related to visual information, wherein the visual information comprises at least one of scene information or style information to which the first image belongs; and
determining, in response to the context being related to the visual information, to receive the second image.

4. The interaction method according to claim 1, further comprising:
generating first reply information according to the first image; and
determining, in response to the first reply information not meeting a target, to receive the second image.

5. The interaction method according to claim 4, further comprising:
determining, in response to the first reply information meeting the target, not to receive the second image.

6. The interaction method according to claim 1, wherein the context comprises a processing instruction, and the interaction method further comprises:
recognizing a text in the first image; and
determining, in response to the processing instruction being a semantic processing instruction for the text, to receive the second image.

7. The interaction method according to claim 1, wherein the context comprises a processing instruction, and the interaction method further comprises:
recognizing a text in the first image; and
determining, in response to the processing instruction being an extraction instruction for the text, not to receive the second image.

8. The interaction method according to claim 1, wherein the reply information is generated by a machine learning model according to the first image, the second image, and prompt information, wherein the prompt information indicates that the first image is a region of interest of the user.

9. The interaction method according to claim 8, the reply information is generated by the machine learning model according to the first image, a first weight of the first image, the second image, and a second weight of the second image, wherein the first weight and the second weight are determined according to the prompt information, and the first weight is greater than the second weight.

10. The interaction method according to claim 1, further comprising:
generating, in response to determining not to receive the second image, the reply information according to the first image.

11. The interaction method according to claim 1, wherein the receiving the first image input by the user comprises:
determining, in response to a selection operation of the user on a partial area of the second image, the partial area as the first image.

12. The interaction method according to claim 1, wherein the receiving the first image input by the user comprises:
displaying guidance information to guide the user to perform a selection operation; and
determining a partial area of the second image selected by the user according to the guidance information as the first image.

13. An electronic device, comprising:
at least one memory; and
at least one processor coupled to the at least one memory, wherein the at least one processor is configured to, based on instructions stored in the at least one memory, perform an interaction method, comprising:
receiving a first image input by a user;
receiving a second image according to at least one of the first image or a context of interaction with the user, wherein the first image is a part of the second image; and
displaying reply information, which is generated according to the first image and the second image.

14. The electronic device according to claim 13, wherein the interaction method further comprises:
determining semantic information of the first image, wherein the semantic information of the first image comprises at least one of an event, a text, an object, an action of the object, a texture, a shape, or a color in the first image; and
determining whether to receive the second image according to the semantic information of the first image.

15. The electronic device according to claim 13, wherein the interaction method further comprises:
determining whether the context is related to visual information, wherein the visual information comprises at least one of scene information or style information to which the first image belongs; and
determining, in response to the context being related to the visual information, to receive the second image.

16. The electronic device according to claim 13, wherein the interaction method further comprises:
generating first reply information according to the first image; and
determining, in response to the first reply information not meeting a target, to receive the second image.

17. A non-transitory computer-readable storage medium, having computer program instructions stored thereon, wherein an interaction method is implemented when the instructions are executed by a processor, and the interaction method comprises:
receiving a first image input by a user;
determining whether to receive a second image according to at least one of the first image or a context of interaction with the user, wherein the first image is a part of the second image; and
displaying reply information, which is generated according to the first image and the second image.

18. The non-transitory computer-readable storage medium according to claim 17, wherein the interaction method further comprises:
determining semantic information of the first image, wherein the semantic information of the first image comprises at least one of an event, a text, an object, an action of the object, a texture, a shape, or a color in the first image; and
determining whether to receive the second image according to the semantic information of the first image.

19. The non-transitory computer-readable storage medium according to claim 17, wherein the interaction method further comprises:
determining whether the context is related to visual information, wherein the visual information comprises at least one of scene information or style information to which the first image belongs; and
determining, in response to the context being related to the visual information, to receive the second image.

20. The non-transitory computer-readable storage medium according to claim 17, wherein the interaction method further comprises:
generating first reply information according to the first image; and
determining, in response to the first reply information not meeting a target, to receive the second image.
